(19) United States
(12) Patent Application Publication
(10) Pub. No.: US 2008/0087694 A1
(43) Pub. Date: Apr. 17, 2008

(54) Hands-free baby carrier

(76) Inventors: Audra Meng, Sunnyvale, CA (US); Jack Boyce, Sunnyvale, CA (US)

Correspondence Address: West & Associates, A PC;Suite 209, 2815 Mitchell Drive, Walnut Creek, CA, 94598, US

(21) Appl. No.: 11/549,041

(22) Filed: Oct. 12, 2006

(51) Int. Cl. A61G 1/00

(52) U.S. Cl. 224/160

(57) ABSTRACT

A baby carrier for hands-free carrying of babies on the adult's hip. The carrier features a wide padded waist belt, shaped baby seat, fleece shoulder panel, and adjustable shoulder straps. It comfortably distributes a baby's weight for long carries, allows wearer to carry baby hands-free, and easily accommodates baby getting up and down.

### BACKGROUND

1. Field of the Invention

The current disclosure relates to a carrier for children worn on an adult's body.

2. Background

Modern parents need help carrying their babies while on the go. As attachment parenting and “babywearing” are becoming more popular, parents need tools to help them keep their babies close. Babywearing is an obvious and natural way to care for a baby—carried babies are more content and cry less.

Carrying a baby on the hip is a natural and convenient way to carry older babies, especially when they want to be picked up and put down constantly. Current baby carriers that can be used for hip carry are uncomfortable or not specifically designed for side carry. Many types of baby carriers are available on the market today. One common type is in the form of a two-ringed sling. Products in this category include the Original Baby Sling by Nojo, the Sling-Ezee by Parenting Concepts, and the Over the Shoulder Baby Holder. These carriers are roughly a cigar-shaped piece of cloth that has two rings at one end. The other end has a short tail that is long and narrow and loops through the rings, forming a pouch for the baby. The sling is worn on one shoulder. While these carriers can be versatile in being adaptable to different carrying positions, it can be uncomfortable to wear for very long periods since the weight of the baby is borne by one shoulder. Further, the carrier is time-consuming to adjust—it requires a lot of tugging on various parts of the fabric to adjust properly, and this needs to be done each time the carrier is used.

The New Native Baby Carrier by New Native, Inc. is a big pouch that can take a baby in horizontally, inclined, or vertically, and is worn over one shoulder. A very wide piece of fabric goes over the adult's shoulder and across the back. While the simple design makes it easy to use, it can be uncomfortable since all the weight goes on one shoulder. The child is simply held in place with the shape of the sling and can easily be dislodged. It is not adjustable in size, and requires the purchase of a new carrier when the child becomes bigger.

The Baby Bundler by the Baby Bundlers is a long piece of cloth made from cotton that is worn on both shoulders at the same time. With the adult holding the baby against the body, the cloth is wrapped around the baby and adult several times to create a bond, and then tied in the back. However, this can be unsafe if the tie should become undone.

Another popular carrier is the baby carrier by BABYBJÖRN. The Baby cradle is worn in the front, with two shoulder straps that circle the neck and a back panel that circles the back of the adult. The baby can be carried facing forward or towards the adult's chest. This carrier works well for small infants up to around 15 lbs, but an older baby's weight makes this carrier uncomfortable as the weight is on the adult's shoulders, neck and back. Furthermore, an older child's head will block the adult's vision since the baby is carried on the upper chest of the adult and in the line of sight.

Carriers specifically designed for hip carry, like the Playtex Hip Hammock, generally have thin nylon webbing straps for the waist belt and shoulder strap. Thin shoulder straps (even with padding around it) that rest on top of the shoulder can ride up onto the wearer's neck, causing discomfort. Thin waist belts do not adequately support baby's weight, and do not distribute the baby's weight evenly over the hips. The baby's weight tends to pull down on the thin waist and shoulder straps, causing the straps to dig in uncomfortably. Two exceptions are the EllaRoo Mei Hip carrier and the Hip Panda carrier—these have fabric that cups the shoulder to prevent the shoulder strap from digging into the neck. However, these carriers have thin waist belts that do not provide enough support. The Hippychick Hipseat has a wide, padded waist belt, but the Hipseat is not meant to be used hands-free.

Using the above prior-art carriers, most babies become too heavy to carry (at 4-5 months old) long before they are able to comfortably walk on their own. These carriers tend to concentrate the weight of the baby on the neck region and back of the adult, where it could easily lead to discomfort or even a bad back.

What is desired, therefore, is a baby carrier that allows parents and caregivers to carry baby naturally on their hip and provides face-to-face contact with the baby, while freeing the adult's hands for other activities. The weight of the baby should be borne primarily by the hip, with the outer shoulder providing additional support and stability.

The carrier should have a wide, padded waist belt that is stiff enough to distribute the weight of the baby along the adult's hip and to provide support.

The carrier should also have a fleece shoulder panel to distribute part of the baby's weight and to provide stability without impeding arm movement. The strap to the shoulder panel should be easily adjustable without having to be detached, to make the carrier easier to put on.

The carrier should further have a shaped baby seat that provides a comfortable seat for the baby.

The carrier should have a streamlined design, making it simple to put on and take off. It should be foldable so that it can be stored easily in a diaper bag.

### SUMMARY OF THE INVENTION

The present disclosure provides a Carrier that features a Wide padded waist belt, shaped baby seat, fleece shoulder area, and adjustable shoulder strap. It comfortably distributes a baby's weight for long carries, allows wearer to carry baby hands-free, and easily accommodates baby getting up and down.

### BRIEF DESCRIPTION OF THE DRAWINGS

FIG. 1 depicts a frontal view of the outer side of an embodiment of the baby carrier as it is laid flat on a surface.

FIG. 2 depicts the inner side of the carrier depicted in FIG. 1.

FIG. 3 depicts an adult wearer using the baby carrier to carry a baby on the wearer's left hip.

### DETAILED DESCRIPTION

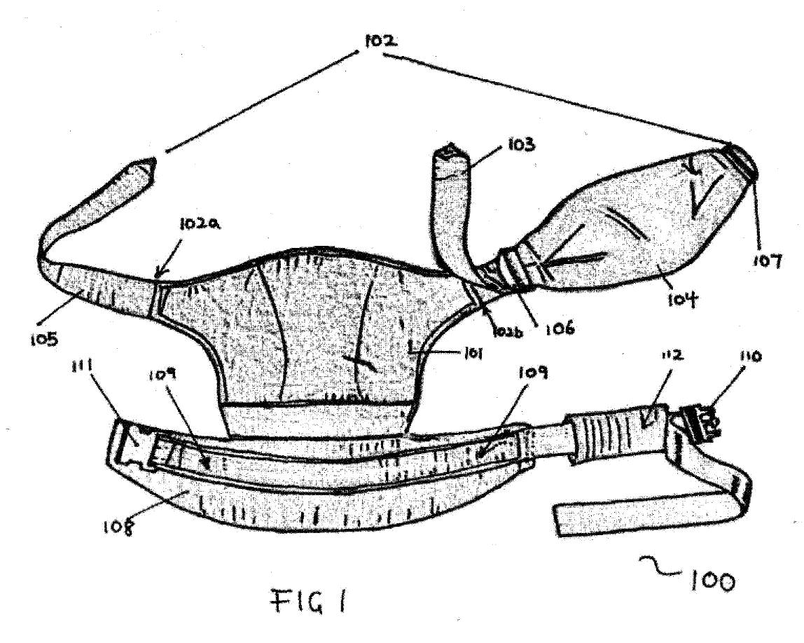

FIG. 1 depicts a planar view of the outer side of the novel baby carrier 100. The carrier has a shaped seat for the baby 101, made out of fabric. The fabric used should be strong but soft and one that can be cleaned repeatedly in a common washer and dryer. The shaped seat 101 can either be rounded with a curve sewn into it, or it can have darts to fit the baby's bottom. (Darts are garment construction features used to shape fabric to the curves of the body. Darts can be straight, for an easy fit, or curved for a closer-to-the body fit.) In a preferred embodiment of the carrier, the seat 101 is three-dimensional, curved and shaped to fit a baby's bottom snugly and securely. The shaped seat is formed by sewing together two pieces of fabric that are cut with the proper curve. This is more precise and is an improvement over darts, which are just sewn into a single piece of fabric. The shaped baby seat ensures the baby and wearer's comfort. The fabric chosen should be soft and breathable to prevent the baby from overheating. The seat 101 can further be made or lined with patterned fabrics, or trimmed to personalize the carrier for wearers. In further embodiments of the carrier, the back of the baby seat may have a pocket or pouch to carry small items.

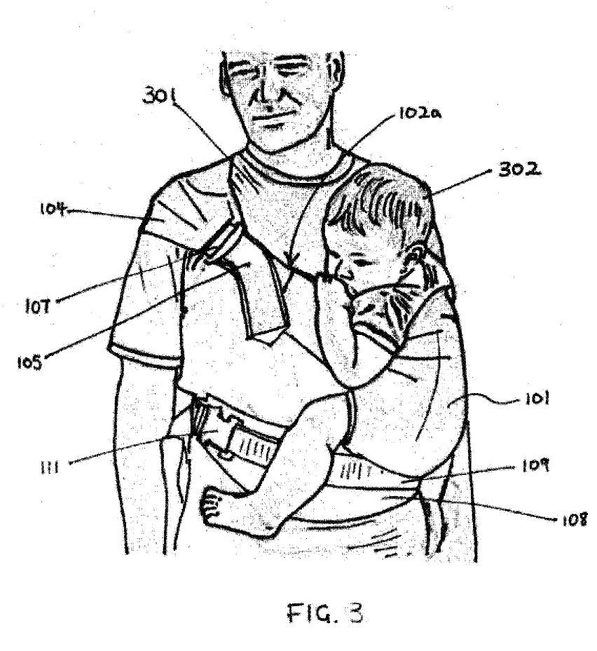

The carrier 100 has a single shoulder harness 102 (shown unconnected in FIG. 1) comprising a right strap 103, a shoulder panel 104, and a left strap 105. To connect the shoulder harness 102, the left strap 105 that extends from the left-hand side of the baby's seat at 102a goes around the wearer's back and shoulder to run through strap adjuster 107 which is integral with shoulder panel 104. The right strap 103 extends from the right-hand side of the baby's seat at 102b and runs through strap adjuster 106 integral with shoulder panel 104. When the carrier is worn on the adult's left side, the left strap 105 will be positioned on the chest of the adult, with right strap 103 going around the wearer's back. (See FIG. 3). The length of the right strap 103 and left strap 105 can be adjusted by means of the strap adjusters 106, 107 so the carrier can be worn on either the right or left hip. This also ensures proper placement of the shoulder panel 104 on the wearer's shoulder opposite the hip where the baby is sitting. (Refer to FIG. 3 below for a view of the shoulder harness when the carrier is in use). In a preferred embodiment of the carrier, the adjusters are sliding bar buckles.

When the baby carrier is in use, the shoulder panel 104 should be placed over the ball of the wearer's outer shoulder, where it won't ride up on the wearer's neck. The shoulder panel 104 should be wide enough to cup the shoulder (See FIG. 3 below). In a preferred embodiment of the carrier, the shoulder panel 104 is made from fleece, which is soft and stretchy enough to conform to the wearer's shoulder and distribute the weight evenly over the shoulder, without impeding the wearer's arm movement. Additional padding on the shoulder may be used for added comfort. The shoulder panel 104 is completely symmetric front and back, so the carrier can be worn on either the right or left hip by rotating the carrier around the wearer's waist to position the baby on either hip.

The attachment of the shoulder straps 105, 103 to the baby seat at points 102a and 102b can be achieved by any method known or convenient. Strap 105 attaches at point 102a, 103 attaches at 102b. Ideally, the shoulder strap should be adjustable while baby is in the carrier. It is preferred to have the adjustable portion attach back to the strap without dangling ends for safety and a streamlined look. The strap adjusters 106, 107 can be any adjusting hardware known or convenient which can securely adjust the length of straps. Optionally, straps 103 and 105 can be lightly padded.

The carrier further has a wide waist belt 108 that is padded with a semi-rigid material and covered with fabric. This material can be stiff foam or any other appropriate material known or convenient, including closed cell foams such as ethylene-vinyl acetate (also known as EVA). The semi-rigid material and the wide shape of the waist belt 108 serves to distribute the weight of the baby around waist of the wearer. This is important because the waist belt 108 (as opposed to the shoulder harness 102) supports most of the baby's weight on the wearer's waist and hips. The waist belt 108 is integral with the baby seat 101 at the top and is attached to a waist strap 109 that runs the length of the waist belt 108. A distal end of the waist strap 109 is looped through a side release buckle 110 such that the length of the waist strap can be adjusted around the wearer's waist. The male portion of the side release buckle 110 clips into the corresponding side release buckle receptor 111 to secure the belt on the wearer's waist. A comfort pad 112 is provided to cushion the wearer's hip on the side opposite to where the baby is carried. In further embodiments of the carrier, the waist strap 109 can be hidden underneath the fabric of the waist belt 108.

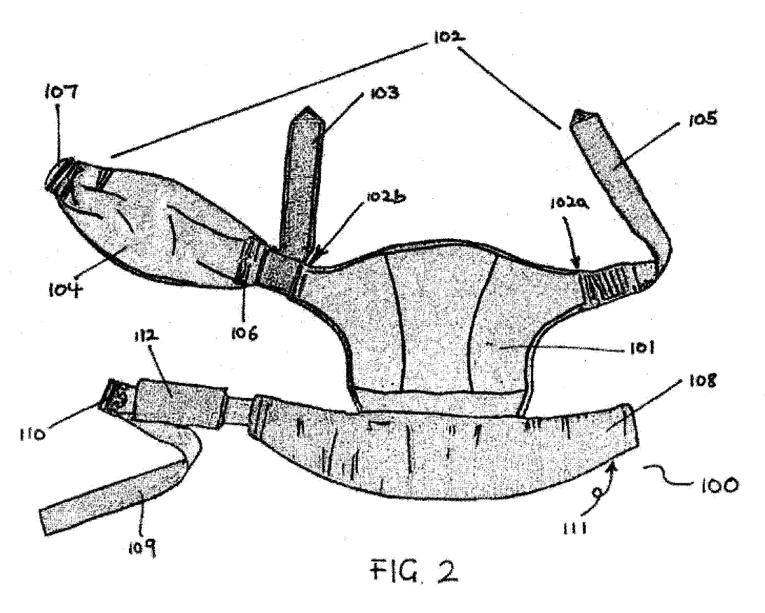

As mentioned above, the carrier can be worn to carry the baby on either the left or right hip as a matter of the wearer's preference. The carrier does not need to be reversed in order to switch to the opposite hip—the baby seat just needs to be shifted to the other hip by swiveling the waist belt around the waist so that the baby seat is shifted to the other hip. The outer shell of the carrier always faces outward. To carry the baby on the left hip, the shoulder panel will be on the adult's right shoulder. To carry the baby on the right hip, the shoulder panel will rest on the adult's left shoulder. FIG. 2 depicts the inner side of the carrier. This side is always against the wearer's body, whether the carrier is worn on the left or right side.

FIG. 3 depicts the carrier in use by an adult wearer 301 to carry a baby 302. In the figure, the adult wearer is carrying the baby on the left hip. The carrier can easily be rotated around to carry the baby on the right hip. To put on the carrier, the waist belt 108 is first buckled around the wearer's 301 waist by means of the waist strap 109, with the baby seat 101 located where the baby 302 will be sitting. Next the baby 302 is placed into the seat 101, with legs straddling the wearer 301. The seat 101 comes up behind the baby's back, and the shoulder harness 102 (which forms a loop when the shoulder straps are connected) is pulled over the baby 302 and wearer's 301 head. The shoulder panel 104 is positioned on the wearer's 301 opposite shoulder, and then the shoulder strap 105 facing the front of the wearer is tightened.

The hip carrier allows the wearer to carry a baby in a secure way hands-free, with easy in/out for an older baby that wants to get up and down a lot. The wide padded waist belt supports most of the baby's weight on the wearer's hips and relieves strain on the wearer's shoulder and neck area compared with other hip carriers currently available. The fleece on the shoulder harness cups the shoulder without pressure points, but is still flexible enough to allow arm movement. The carrier will provide a comfortable way to carry baby on either hip, with adjustable sizing, and is easy to put on and take off.

Although the invention has been described In conjunction with specific embodiments thereof, it is evident that many alternatives, modifications and variations will be apparent to those skilled in the art. Accordingly, the apparatus as described and hereinafter claimed is intended to embrace all such alternatives, modifications and variations that fall within the spirit and broad scope of the appended claims.

What is claimed is:

1. A baby carrier that is worn over an adult's body, comprising:
a seat for a baby to sit in,
a shoulder harness attached to said seat, said shoulder harness comprising a left strap, a right strap and a shoulder panel,
a waist belt attached to said seat, said waist belt having padding constructed of a semi-rigid material, wherein the baby is carried on the hip on the adult.

2. The baby carrier of claim 1, wherein the carrier can be worn to carry the baby on either hip of the adult.

3. The baby carrier of claim 1 further comprising a waist strap.

4. The baby carrier of claim 3, wherein a length of left strap, the right strap and the waist strap are adjustable.

5. The baby carrier of claim 3, further comprising a comfort pad attached to the waist strap.

6. The baby carrier of claim 1, wherein the shoulder panel is made from fleece.

7. The baby carrier of claim 1, wherein the shoulder panel conforms to the wearer's shoulder without impeding the wearer's arm movement.

8. The baby carrier of claim 1, wherein the semi-rigid material is stiff enough to distribute the weight of the baby along the adult's hip and to provide support.

9. The baby carrier of claim 1, wherein the shoulder panel is generally symmetrical front and back.

10. The baby carrier of claim 1, wherein the seat is shaped to fit the back, buttocks and thighs of a baby.

11. The baby carrier of claim 1, wherein the waist belt is secured around the wearer's waist by means of a buckle.

12. The baby carrier of claim 11, wherein the buckle is a quick-release buckle.

13. The baby carrier of claim 1, further comprising a pocket on the seat for carrying small objects.

14. The baby carrier of claim 1, further comprising a pocket on the waist belt for carrying small objects.

15. The baby carrier of claim 1, wherein the seat comprises two pieces of fabric cut with a particular curve and sewn together.

16. The baby carrier of claim 1, characterized by adjustment means provided on the shoulder harness to enable the length of the right or left strap to be adjusted.

17. The baby carrier of claim 16, wherein the adjustment means do not detach when the wearer puts on the carrier.

18. The baby carrier of claim 16, wherein the buckle is a sliding bar buckle.

19. A baby carrier that is worn over an adult's body, consisting of:
a seat for a baby to sit in,
a shoulder harness attached to said seat, said shoulder harness comprising a left strap, a right strap and a shoulder panel, a waist belt attached to said seat, said waist belt having padding constructed of a semi-rigid material, and a waist strap to secure the waist belt around the wearer's waist, wherein the baby is carried on the hip on the adult.
